(19) United States
(12) Patent Application Publication
(10) Pub. No.: US 2019/0345323 A1
(43) Pub. Date: Nov. 14, 2019

(54) RESIN COMPOSITION FOR PRINTED CIRCUIT BOARD AND INTEGRATED CIRCUIT PACKAGE, AND PRODUCT USING THE SAME

(71) Applicant: SAMSUNG ELECTRONICS CO., LTD., Suwon-si (KR)

(72) Inventors: Ki-Seok KIM, Suwon-si (KR); Hyung-Mi JUNG, Suwon-si (KR); Ji-Hye SHIM, Suwon-si (KR); Hwa-Young LEE, Suwon-si (KR)

(73) Assignee: SAMSUNG ELECTRONICS CO., LTD., Suwon-si (KR)

(21) Appl. No.: 16/353,184

(22) Filed: Mar. 14, 2019

(30) Foreign Application Priority Data
May 11, 2018 (KR) 10-2018-0054454
Aug. 10, 2018 (KR) 10-2018-0093862

(51) Int. Cl. C08L 63/00; C08K 5/3445; C08K 3/36

(52) U.S. Cl. CPC C08L 63/00; C08K 5/3445; C08L 2205/02; C08L 2203/20; C08L 2205/03; C08K 3/36

(57) ABSTRACT

A resin composition for a printed circuit board and an IC package, and a product using the same, is provided. The resin composition includes an epoxy resin composite comprising 5 to 10 parts by weight of a bisphenol “A” type epoxy resin, 5 to 10 parts by weight of a naphthalene epoxy resin, 10 to 40 parts by weight of a cresol novolac epoxy resin, more than 10 to 30 parts by weight of a rubber-modified epoxy resin, and 30 or more but less than 50 parts by weight of a biphenylaralkyl novolac resin, a hardener composite comprising a dicyclopentadiene type hardener, a biphenylaralkyl novolac type hardener, and a xylok type hardener, a hardening accelerator, an inorganic filler, and a thickener.

### CROSS-REFERENCE TO RELATED APPLICATIONS

This application claims the benefit under 35 USC § 119(a) of Korean Patent Application No. 10-2018-0054454 filed on May 11, 2018 and Korean Patent Application No. 10-2018-0093862 filed on Aug. 10, 2018, in the Korean Intellectual Property Office, the entire disclosures of which are incorporated herein by reference for all purposes.

### BACKGROUND

### 1. Field

This application relates to a resin composition for a printed circuit board (PCB) and an integrated circuit (IC) package, and a product using the same.

### 2. Description of Related Art

There is an increased demand for high-performance communication devices and mobile devices with the rapid growth of information technologies in accordance with mobilization based on rapidly growing digitalization and networking of electronics industries. There is also an increased demand for high-performance materials for multilayer printed circuit boards and packages including the same in addition to miniaturized and high-performance mobile devices.

Generally, molding materials for packages are mainly a granule type or a liquid type. In order to use such molding materials, an expensive compression molding equipment is typically implemented, and the processing time may be prolonged. Thus, there is a need for developing film-typed molding materials such as insulating materials for printed circuits in order to overcome these disadvantages. When the film-typed molding material is used as a molding material for packaging, it is possible to utilize relatively cheap vacuum lamination equipment and further to reduce the processing time since a molding process and a hardening process can be separated.

Also, in panel level packaging (PLP) based on a printed circuit board, a build-up material can be used in various ways as a back-side redistribution layer (RDL) and a molding material.

Therefore, insulation compositions for forming thick films should be developed, which can secure stability and reliability of PCBs and packages.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a resin composition includes an epoxy resin composite comprising epoxy groups, the epoxy resin composite comprising 5 to 10 parts by weight of a bisphenol “A” type epoxy resin, 5 to 10 parts by weight of a naphthalene epoxy resin, 10 to 40 parts by weight of a cresol novolac epoxy resin, more than 10 to 30 parts by weight of a rubber-modified epoxy resin, and 30 or more but less than 50 parts by weight of a biphenylaralkyl novolac resin, a hardener composite comprising a dicyclopentadiene type hardener, a biphenylaralkyl novolac type hardener, and a xylok type hardener, a hardening accelerator, an inorganic filler, and a thickener.

The resin composition may further include a thermoplastic resin.

The resin composition may be implemented with at least one of a printed circuit board and an integrated circuit (IC) packaging.

A total content of the hardener composite may be in a range of 0.3 to 1.5 equivalents based on a mixed equivalent of the epoxy groups of the epoxy resin composite.

A content ratio of the dicyclopentadiene type hardener:the biphenylaralkyl novolac type hardener:the xylok type hardener in the hardener composite may be 1:1:0.5 to 1.

The dicyclopentadiene type hardener in the hardener composite may be contained in an amount of 0.1 to 0.5 parts by weight based on a total weight of the epoxy resin composite.

The biphenylaralkyl novolac type hardener in the hardener composite may be contained in an amount of 0.1 to 0.5 parts by weight based on 100 parts by weight of the epoxy resin composite.

The Xylok type hardener in the hardener composite may be contained in an amount of 0.1 to 0.5 parts by weight based on 100 parts by weight of the epoxy resin composite.

The hardening accelerator may be contained in an amount of 0.1 to 1 part by weight based on 100 parts by weight of the epoxy resin composite.

The inorganic filler may be contained in an amount of 30 to 70 parts by weight based on 100 parts by weight of the epoxy resin composite.

The filler may be an inorganic filler

In a general aspect, an insulation film includes the resin composition.

The insulation film may be applied to at least one of a build-up layer of a printed circuit board, a mold layer of panel level packaging, and a redistribution layer.

The insulation film may have a thickness of 200 μm or more.

The insulation film may have a moisture content of 0.5 wt % or less after hardening.

The insulation film may have a thermal expansion coefficient of 20 ppm/° C. or less.

In a general aspect, a product includes the insulation film.

The product may be at least one of a printed circuit board and an integrated circuit (IC) package.

Other features and aspects will be apparent from the following detailed description, the drawings, and the claims.

### BRIEF DESCRIPTION OF THE DRAWINGS

FIG. 1 is a schematic view illustrating an example of a package including a resin composition, wherein an insulation film prepared by using the resin composition is provided in an “A” portion;

FIG. 2 is a graph illustrating an example of viscosity and thickness of a resin composition according to an embodiment of this disclosure based on an amount of thickener;

FIG. 3A shows examples of results of reliability testing of a reference after 1,000 cycles in a thermal cycle tester in order to investigate thermal stability and mechanical strength; and

FIG. 3B shows examples of results of reliability testing of an embodiment of this disclosure having a low coefficient of thermal expansion after 1,000 cycles in a thermal cycle tester in order to investigate thermal stability and mechanical strength.

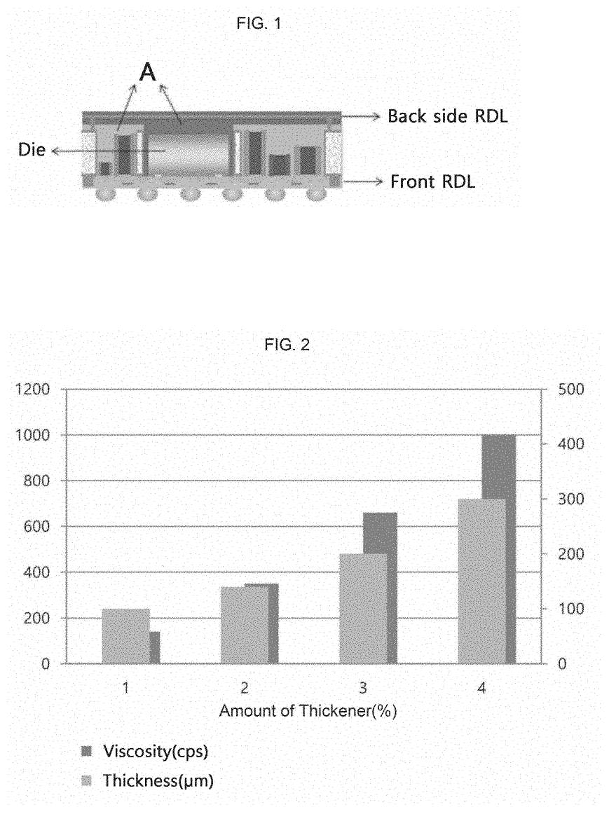

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “include,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Throughout the description of the present disclosure, when describing a certain technology is determined to evade the point of the present disclosure, the pertinent detailed description will be omitted.

In the following description, well-known functions or constructions are not described in detail since they would obscure the invention in unnecessary detail.

The features of the examples described herein may be combined in various ways as will be apparent after an understanding of the disclosure of this application. Further, although the examples described herein have a variety of configurations, other configurations are possible as will be apparent after an understanding of the disclosure of this application.

A. Resin Composition

A resin composition for a printed circuit board and/or an IC package according to an embodiment of this disclosure includes: (a) an epoxy resin composite including 5 to 10 parts by weight of a bisphenol “A” type epoxy resin, 5 to 10 parts by weight of a naphthalene epoxy resin, 10 to 40 parts by weight of a cresol novolac epoxy resin, more than 10 to 30 parts by weight of a rubber-modified epoxy resin, and 30 or more but less than 50 parts by weight of a biphenylaralkyl novolac resin; (b) a hardener composite including a dicyclopentadiene type (DCPD type) hardener, a biphenylaralkyl novolac type hardener, and a xylok type hardener; (c) a hardening accelerator; (d) a thermoplastic resin (e) an inorganic filler; and (f) a thickener.

(a) Epoxy Resin Composite

Bisphenol “A” Epoxy Resin (DGEBF Type Epoxy Resin)

In an example, bisphenol “A” type epoxy resin may be contained in an amount of 5 to 10 parts by weight based on the total weight of the epoxy resin composite. When the content of the bisphenol “A” type epoxy resin is less than 5 parts by weight, adhesion with a wiring material may be deteriorated. On the other hand, when the content is more than 10 parts by weight, thermal stability and electrical properties may be deteriorated.

Naphthalene Epoxy Resin

In an example, the epoxy resin composite may include a naphthalene epoxy resin in order to provide a cured product having heat resistance, low thermal expansion property and low hygroscopic property. The naphthalene epoxy resin may be contained in an amount of 5 to 10 parts by weight based on the total weight of the epoxy resin composite. When the amount of the naphthalene epoxy resin is less than 5 parts by weight, thermal stability may be deteriorated. On the other hand, when the amount of the naphthalene epoxy resin is more than 10 parts by weight, thermal conductivity and thermal resistance may be deteriorated.

Cresol Novolac Epoxy Resin

In an example, the epoxy resin composite may include a cresol novolac epoxy resin to provide a cured product having improved thermal stability and high heat resistance and moisture resistance. The content of the cresol novolac epoxy resin may be 10 to 40 parts by weight based on the total weight of the epoxy resin composite. When the content of the cresol novolac epoxy resin is less than 10 parts by weight, it may be difficult to exhibit desired properties. On the other hand, when the content is more than 40 parts by weight, electrical or mechanical properties may be deteriorated.

Rubber-Modified Epoxy Resin

In an example, the epoxy resin composite may include a rubber-modified epoxy resin. The rubber-modified epoxy resin may be contained in an amount of more than 10 to 30 parts by weight based on the total weight of the epoxy resin composite. When the content of the rubber-modified epoxy resin is 10 parts by weight or less, it may be difficult to obtain mechanical stability of an insulation film and it may not be suitable for forming a circuit board to which the insulating material is applied. On the other hand, when the content is more than 30 parts by weight, the effect may not be sufficiently improved.

Biphenylaralkyl Novolac Resin

In an example, the epoxy resin composite may include a biphenylaralkyl novolac resin to provide a cured product having excellent heat resistance. The biphenylaralkyl novolac resin may have excellent physical properties and crystallinity due to the biphenyl group having a symmetrical structure and particularly, may have many excellent physical properties such as low melt viscosity, low stress and high adhesion. The biphenylaralkyl novolac resin may be contained in an amount of 30 or more but less than 50 parts by weight based on the total weight of the epoxy resin composite. When the content of the biphenylaralkyl novolac resin is less than 30 parts by weight, it may be difficult to impart adequate heat resistance in the insulation film. On the other hand, when the content is 50 or more parts by weight, the curability may be deteriorated and the adhesion with a wiring layer may be also deteriorated.

(b) Hardener

In an example, hardener contained in the resin composition of this disclosure may be a hardener composite including a dicyclopentadiene (DCPD) type hardener, a biphenylaralkyl novolac hardener, and a xylok type hardener in order to improve the coefficient of thermal expansion (CTE) characteristics and hardening density. The above-mentioned hardener composite can achieve the effects of improving flame retardancy and adhesion with a wiring layer and the like of the resin composition of this disclosure by supplementing the shortcomings of each hardener. The content ratio of the DCPD type hardener:the biphenylaralkyl novolac type hardener:the Xylok type hardener may be, but is not limited to, 1:1:0.5 to 1. The hardener composite may be contained in an amount of 0.3 to 1.5 equivalents based on the mixed equivalent of the epoxy groups of the epoxy resin composite, and more preferably 0.8 equivalents. When the equivalent ratio of the hardener composite is less than 0.3, the flame retardancy of the resin composition may be deteriorated. On the other hand, when the equivalent ratio is more than 1.5, the adhesion to the wiring layer may be deteriorated and the storage stability may also be deteriorated.

Dicyclopentadiene Type (DCPD Type) Hardener

In an example, the resin composition of this disclosure may include a dicyclopentadiene type hardener in order to facilitate controlling curability and provide excellent mechanical and electrical properties and water resistance. Although not limited thereto, the DCPD type hardener may be contained in an amount of 0.1 to 0.5 parts by weight based on the total weight of the epoxy resin composite. When the content of the DCPD type hardener is less than 0.1 parts by weight, the curability may be deteriorated. On the other hand, when the content is more than 0.5 parts by weight, synergistic effects of the hardener composite may not be expected.

Biphenylaralkyl Novolac Type Hardener

In an example, the resin composition of this disclosure may include a biphenylaralkyl novolac type hardener to provide satisfied heat resistance. The biphenylaralkyl novolac type hardener may be contained in, but is not limited to, an amount of 0.1 to 0.5 parts by weight based on the total weight of the epoxy resin composite. When the content of the biphenylaralkyl novolac type hardener is less than 0.1 parts by weight, the adhesion with the wiring is decreased. On the other hand, when the content is more than 0.5 parts by weight, synergistic effects of the hardener composite may not be expected.

Xylok Type Hardener

In an example, the resin composition of this disclosure may include a xylok type hardener in order to control a hardening rate. The xylok type hardener is not limited thereto, but may be included in an amount of 0.1 to 0.5 parts by weight based on the total weight of the epoxy resin composite. When the content of the xylok type hardener is less than 0.1 parts by weight, the reliability is lowered due to shortage of a hardening portion. On the other hand, when the content of the xylok type hardener is more than 0.5 parts by weight, the hardening rate may not be controlled, and the degree of removal of voids may be lowered or the tensile strength of a film may be also lowered.

(c) Hardening Accelerator

A hardening accelerator included in the resin composition of this disclosure is not limited thereto, but may be an imidazole-based compound, and examples thereof include 2-ethyl-4methyl imidazole, 1-(2-cyanoethyl)-2-alkyl imidazole, 2-phenyl imidazole and a mixture thereof. The hardening accelerator is not limited thereto, but may be included in an amount of 0.1 to 1 parts by weight based on the total weight of the epoxy resin composite. When the content of the hardening accelerator is less than 0.1 parts by weight, the hardening rate may be remarkably lowered. On the other hand, when the content is more than 1 part by weight, hardening may occur too rapidly to obtain desired physical properties.

(d) Inorganic Filler

An inorganic filler included in the resin composition of this disclosure may be, but is not limited to, at least one of barium titanium oxide, barium strontium titanate, titanium oxide, lead zirconium titanate, lead lanthanum zirconate titanate, lead magnesium niobate-lead titanate, silver, nickel, nickel-coated polymer sphere, gold-coated polymer sphere, tin solder, graphite, tantalum nitride, metal silicon nitride, carbon black, silica, clay, aluminum, and aluminum borate.

The inorganic filler is not limited thereto, but may be included in an amount of 30 to 70 parts by weight based on the total weight of the epoxy resin composite. When the content of the inorganic filler is less than 30 parts by weight, it may be difficult to expect a desired improvement in the mechanical properties. On the other hand, when the content is more than 70 parts by weight, phase separation may occur. In addition, the inorganic filler may be surface-treated with a silane coupling agent, and it may be more preferable to include fillers in different sizes and shapes. Although not limited thereto, as the silane coupling agent, various kinds of amino-based, epoxy-based, acrylic-based, vinyl-based, and the like may be used.

The inorganic filler may be a flame-retardant inorganic filler for printed circuit boards including spherical fillers of different sizes.

(e) Thickener

The resin composition of this disclosure may include a thickener to form a high viscosity insulation composition. The thickener may be selected from inorganic and/or organic thickeners.

Although not limited thereto, the organic thickener may be at least one selected from urea-modified polyamides, waxes, thixotropic resins, cellulose ethers, starches, natural hydrocolloids, synthetic biopolymers, polyacrylates, alkali-activated acrylic acid emulsions, and fatty acid alkanamides.

Although not limited thereto, the inorganic thickener may be at least one of magnesium oxide, magnesium hydroxide, amorphous silica and layered silicate.

Although not limited thereto, the thickener may be selected from inorganic thickeners such as silica. The silica can effectively prevent precipitation without impairing the properties of the resin composition.

The thickener may be included in an amount of 1 to 10 parts by weight based on 100 parts by weight of the resin composition, preferably in an amount of 1 to 3 parts by weight.

Although not limited thereto, the resin composition of this disclosure may use a different solvent having a different boiling point for the coating and filming of the resin composition and further include at least one additive such as a thermoplastic resin, a surface tension controlling agent, a defoaming agent, or the like.

(f) Thermoplastic Resin

A thermoplastic resin of the resin composition of this disclosure may be contained in an amount of 5 to 10 parts by weight based on the total weight of the epoxy resin composite and the hardener composite. When the content of the thermoplastic resin is less than 5 parts by weight based on the total weight of the epoxy resin composite and the hardener composite, thermoplasticity of the resin composition may be lowered and brittleness may be increased. On the other hand, when the content is more than 10 parts by weight, thermal expansion of the insulation layer may be increased and mechanical physical properties may be thus degraded.

The thermoplastic resin may be at least one of polyvinyl acetal resin, phenoxy resin, polyimide resin, polyamideimide resin, polyetherimide resin, polysulfone resin, polyethersulfone resin, polyphenylene ether resin, polycarbonate resin, polyetheretherketone resin, polyester resin, phenol resin, fluorine-based thermoplastic resin and polyacetal resin, but is not limited thereto.

(g) Surface Controlling Agent

A surface controlling agent contained in the resin composition of this disclosure may be at least one of, but not limited to, an ammonium-based compound, an amine-based compound, an imine-based compound, an amide-based compound and a mixture thereof.

(h) Antifoaming Agent

An antifoaming agent contained in the resin composition of this disclosure plays a role of suppressing foaming to improve the hygroscopic property by imparting dispersing effects. When bubbles are generated, the bubbles float on the substrate and cause defective physical properties. By using such a defoaming agent, such defects can be prevented. The antifoaming agent may be, but is not limited to, a silicone type or a non-silicone polymer type.

(i) Solvent

In order to facilitate coating and film formation using the resin composition of this disclosure, a different solvent having a different boiling point may be used. The resin composition may be used by dissolving it in a mixed solvent such as 2-methoxyethanol, methylethylketone (MEK), methylenechloride (MC), dimethylformamide (DMF), methylcellosolve (MCS).

B. Insulation Film

By using the resin composition of this disclosure, an insulation film may be produced having an improved hygroscopic property, reliability, thermal stability and mechanical properties.

The insulation film may be applied to a buildup layer of a printed circuit board, a mold layer of PLP, and a back-side redistribution layer (RDL).

A thickness of the insulation film may be 200 μm or more. When the resin composition of this disclosure is used, it is easy to control the thickness during film casting, and it is thus possible to manufacture a film having a thickness of 200 μm or more. It can be thus used from small size to large size products.

The insulation film may have a moisture content of 0.5 wt % or less after hardening, although it is not limited thereto.

Further, it is possible to provide a package product having a coefficient of thermal expansion of 20 ppm/° C. or less and excellent thermal stability of the insulation film.

C. Package

A printed circuit board and an IC package with an improved hygroscopic property, reliability, thermal stability and mechanical properties using the insulation film of this disclosure can be provided. Particularly, the insulation film of this disclosure can be applied to a buildup layer of a printed circuit board, a mold film of PLP, and a back-side RDL.

Hereinafter, although more detailed descriptions will be given by examples, those are only for explanation and there is no intention to limit the disclosure. In the following examples, only examples using specific compounds are exemplified. However, it is apparent to those skilled in the art that equivalents of similar compounds can be exhibited even when these equivalents are used.

### EXAMPLES

Preparation of Resin Composition

Resin compositions of Example 1 and Comparative Examples 1 to 7 were prepared in which each resin composition includes an epoxy resin composite including a bisphenol “A” epoxy resin, a naphthalene epoxy resin, a cresol novolac epoxy resin, a rubber-modified epoxy resin, and a biphenylaralkyl novolac epoxy resin; a hardener composite including a DCPD type hardener, biphenylaralkyl novolac hardener and a Xylok type hardener; a thermoplastic resin; a hardening accelerator; an inorganic filler; and an organic and/or inorganic thickener with the compositions shown in Tables 1 and 2.

More particularly, the hardener composite was added in an amount of 0.8 equivalent based on the epoxy resin composite and spherical amino-treated silica slurry having a size distribution of 500 nm to 5 μm was added and stirred at 300 rpm for 3 hours.

A hardening accelerator, a surface controlling additive and a thickener were added to the mixture and further mixed for 1 hour to provide a resin composition. The compositions of the resin compositions of Example 1 and Comparative Examples 1 to 7 are shown in detail in Table 1 and Table 2.

The resin compositions of Comparative Examples 1 to 4 are the same as the composition of Example 1, except for the composition of the epoxy resin composite and the resin compositions of Comparative Example 5 to 7 are the same as the composition of Example 1, except for the composition of the hardener composite.

TABLE 1

| | | | Comparative | Comparative | Comparative | Comparative |
|---|---|---|---|---|---|---|
| Components | | Example1 | Example 1 | Example 2 | Example 3 | Example 4 |
| Epoxy resin | DGEBA | 8.0% | 15.0% | 8.0% | 18.0% | 28.0% |
| | type epoxy | | | | | |
| | Naphthalene | 7.0% | 0% | 7.0% | 17.0% | 27.0% |
| | type epoxy | | | | | |
| | Cresol novolac | 25.0% | 25.0% | 15.0% | 25.0% | 25.0% |
| | type epoxy | | | | | |
| | Rubber-modified | 20.0% | 20.0% | 10.0% | 20.0% | 20.0% |
| | epoxy | | | | | |
| | Biphenyl | 40.0% | 40.0% | 50.0% | 20.0% | — |
| | aralkyl novolac | | | | | |
| | type epoxy | | | | | |
| Hardener | DCPD type | 0.3 based on | 0.3 based on | 0.3 based on | 0.3 based on | 0.3 based on |
| | | the total | the total | the total | the total | the total |
| | | weight of | weight of | weight of | weight of | weight of |
| | | epoxy resin | epoxy resin | epoxy resin | epoxy resin | epoxy resin |
| | | composite | composite | composite | composite | composite |
| | Biphenyl aralkyl | 0.3 based on | 0.3 based on | 0.3 based on | 0.3 based on | 0.3 based on |
| | novolac type | the total | the total | the total | the total | the total |
| | | weight of | weight of | weight of | weight of | weight of |
| | | epoxy resin | epoxy resin | epoxy resin | epoxy resin | epoxy resin |
| | | composite | composite | composite | composite | composite |
| | Xylok type | 0.2 based on | 0.2 based on | 0.2 based on | 0.2 based on | 0.2 based on |
| | | the total | the total | the total | the total | the total |
| | | weight of | weight of | weight of | weight of | weight of |
| | | epoxy resin | epoxy resin | epoxy resin | epoxy resin | epoxy resin |
| | | composite | composite | composite | composite | composite |
| Thermoplastic | HR-6 | 8 phr based on | 8 phr based on | 8 phr based on | 8 phr based on | 8 phr based on |
| resin | | the total | the total | the total | the total | the total |
| | | weight of | weight of | weight of | weight of | weight of |
| | | epoxy resin | epoxy resin | epoxy resin | epoxy resin | epoxy resin |
| | | composite and | composite and | composite and | composite and | composite and |
| | | the hardener | the hardener | the hardener | the hardener | the hardener |
| | | composite | composite | composite | composite | composite |
| Hardening | 2E4MZ | 0.2 based on | 0.2 based on | 0.2 based on | 0.2 based on | 0.2 based on |
| accelerator | | the total | the total | the total | the total | the total |
| | | weight of | weight of | weight of | weight of | weight of |
| | | epoxy resin | epoxy resin | epoxy resin | epoxy resin | epoxy resin |
| | | composite | composite | composite | composite | composite |
| Inorganic | SiO₂ | 63% based on | 63% based on | 63% based on | 63% based on | 63% based on |
| filler | | the total | the total | the total | the total | the total |
| | | weight of | weight of | weight of | weight of | weight of |
| | | epoxy resin | epoxy resin | epoxy resin | epoxy resin | epoxy resin |
| | | composite and | composite and | composite and | composite and | composite and |
| | | the hardener | the hardener | the hardener | the hardener | the hardener |
| | | composite | composite | composite | composite | composite |
| Thickener | Inorganic/organic | 1~3% based on | 1~3% based on | 1~3% based on | 1~3% based on | 1~3% based on |
| | thickener | the total | the total | the total | the total | the total |
| | | weight of resin | weight of resin | weight of resin | weight of resin | weight of resin |
| | | composition | composition | composition | composition | composition |
| Additive | BYK-337 | 1.50 phr | 1.50 phr | 1.50 phr | 1.50 phr | 1.50 phr |

TABLE 2

| | | | Comparative | Comparative | Comparative |
|---|---|---|---|---|---|
| Components | | Example 1 | Example 5 | Example 6 | Example 7 |
| Epoxy resin | DGEBA | 8.0% | 8.0% | 8.0% | 8.0% |
| | type epoxy | | | | |
| | Naphthalene | 7.0% | 7.0% | 7.0% | 7.0% |
| | type epoxy | | | | |
| | Cresol novolac | 25.0% | 25.0% | 25.0% | 25.0% |
| | type epoxy | | | | |
| | Rubber-modified | 20.0% | 20.0% | 20.0% | 20.0% |
| | epoxy | | | | |
| | Biphenyl | 40.0% | 40.0% | 40.0% | 40.0% |
| | aralkyl novolac | | | | |
| | type epoxy | | | | |
| Hardener | DCPD type | 0.3 based on | 0.2 based on | 0.4 based on | 0.4 based on |
| | | the total | the total | the total | the total |
| | | weight of | weight of | weight of | weight of |
| | | epoxy resin | epoxy resin | epoxy resin | epoxy resin |
| | | composite | composite | composite | composite |
| | Biphenyl aralkyl | 0.3 based on | 0.5 based on | 0.4 based on | 0.1 based on |
| | novolac type | the total | the total | the total | the total |
| | | weight of | weight of | weight of | weight of |
| | | epoxy resin | epoxy resin | epoxy resin | epoxy resin |
| | | composite | composite | composite | composite |
| | Xylok type | 0.2 based on | 0.1 based on | 0 based on | 0.3 based on |
| | | the total | the total | the total | the total |
| | | weight of | weight of | weight of | weight of |
| | | epoxy resin | epoxy resin | epoxy resin | epoxy resin |
| | | composite | composite | composite | composite |
| Thermoplastic resin | HR-6 | 8 phr based on | 8 phr based on | 8 phr based on | 8 phr based on |
| | | the total | the total | the total | the total |
| | | weight of | weight of | weight of | weight of |
| | | epoxy resin | epoxy resin | epoxy resin | epoxy resin |
| | | composite and | composite and | composite and | composite and |
| | | the hardener | the hardener | the hardener | the hardener |
| | | composite | composite | composite | composite |
| Hardening | 2E4MZ | 0.2 based on | 0.2 based on | 0.2 based on | 0.2 based on |
| accelerator | | the total | the total | the total | the total |
| | | weight of | weight of | weight of | weight of |
| | | epoxy resin | epoxy resin | epoxy resin | epoxy resin |
| | | composite | composite | composite | composite |
| Inorganic | SiO₂ | 63% based on | 63% based on | 63% based on | 63% based on |
| filler | | the total | the total | the total | the total |
| | | weight of | weight of | weight of | weight of |
| | | epoxy resin | epoxy resin | epoxy resin | epoxy resin |
| | | composite and | composite and | composite and | composite and |
| | | the hardener | the hardener | the hardener | the hardener |
| | | composite | composite | composite | composite |
| Thickener | Inorganic/organic | 1~3% based on | 1~3% based on | 1~3% based on | 1~3% based on |
| | thickener | the total | the total | the total | the total |
| | | weight of resin | weight of resin | weight of resin | weight of resin |
| | | composition | composition | composition | composition |
| Additive | BYK-337 | 1.50 phr | 1.50 phr | 1.50 phr | 1.50 phr |

Preparation of the Insulation Film

The prepared insulation composition was cast on a polyethylene terephthalate (PET) film to a thickness of 200 μm or more to provide a roll-type film product, which was used as a film-type molding material.

### Experimental Example

Evaluation of Physical Properties and Reliability

The adhesion of the film to Cu was 0.5 kgf/cm or more in evaluating physical properties of the molding material. When the film was used as a molding material for packaging, it was confirmed that the reliability of the package satisfied both Highly Accelerated Stress Test (HAST) and Thermal Cycle (TC) reliability criteria.

It was also confirmed that the prepared molding material may have a low hygroscopic property and excellent reliability in static humidity systems (two reflow cycles after 48 hours under the condition of 85° C./85% RH).

The dissipation factor (Df) was found to be less than 0.01 tangent (δ).

Table 3 below illustrates mechanical properties of chemical copper adhesion, moisture content and coefficient of thermal expansion (CTE) of the films prepared from the resin compositions of Example 1 and Comparative Examples 1 to 4. The resin compositions of Comparative Examples 1 to 4 are the same as the composition of Example 1, except for the content of each epoxy resin in the epoxy resin composite.

TABLE 3

| | | Comparative | Comparative | Comparative | Comparative |
|---|---|---|---|---|---|
| | Example 1 | Example 1 | Example 2 | Example 3 | Example 4 |
| DGEBA type epoxy | 8 | 15 | 8 | 18 | 28 |
| Naphthalene type epoxy | 7 | 0 | 7 | 17 | 27 |
| Cresol novolac type epoxy | 25 | 25 | 15 | 25 | 25 |
| Rubber-modified epoxy | 20 | 20 | 10 | 20 | 20 |
| Biphenylaralkyl | 40 | 40 | 50 | 20 | — |
| novolac type epoxy | | | | | |

Physical properties

| | | | | | |
|---|---|---|---|---|---|
| Chemical copper | >0.5 | 0.42 | 0.37 | — | — |
| adhesion(kgf/cm) | | | | | |
| Moisture content(wt. %) | <0.5 | — | — | 0.61 | 0.7 |
| CTE(ppm/° C.) | <20 | 25 | — | 27 | — |

As illustrated in Table 3, when Example 1 and Comparative Examples 1 to 4 were compared, it was found that only the resin composition of Example 1 showed the chemical copper adhesion of 0.5 kgf/cm or more, the moisture content of 0.5 wt % or less, and the coefficient of thermal expansion of less than 20 ppm/° C.

In Example 1 and Comparative Example 2, when the content of the rubber-modified epoxy resin was 10 parts by weight or less and the content of the biphenylaralkyl novolac resin was 50 parts by weight or more, it was difficult to obtain the mechanical stability of the insulation film and the chemical copper adhesion was deteriorated.

Table 4 below illustrates mechanical properties of chemical copper adhesion, moisture content and coefficient of thermal expansion (CTE) of the films prepared from the resin compositions of Example 1 and Comparative Example 5 to 7. The resin compositions of Comparative Examples 5 to 7 are the same as the composition of Example 1, except for the content of each hardener in the hardener composite.

The resin compositions of Comparative Examples 5 to 7 have a composition ratio of DCPD type hardener:biphenylaralkyl novolac type hardener:Xylok type hardener in the hardener composite beyond the range of 1:1:0.5 to 1.

TABLE 4

| | | Comparative | Comparative | Comparative |
|---|---|---|---|---|
| | Example 1 | Example 5 | Example 6 | Example 7 |
| DCPD type | 0.3 | 0.2 | 0.4 | 0.4 |
| hardener | | | | |
| Biphenylaralkyl | 0.3 | 0.5 | 0.4 | 0.1 |
| novolac type | | | | |
| hardener | | | | |
| Xylok type | 0.2 | 0.1 | 0 | 0.3 |
| hardener | | | | |

Physical properties

| | | | | |
|---|---|---|---|---|
| Chemical copper | >0.5 | 0.44 | 0.4 | 0.41 |
| adhesion(kgf/cm) | | | | |
| Moisture | <0.5 | 0.56 | 0.55 | 0.51 |
| content(wt. %) | | | | |
| CTE(ppm/° C.) | <20 | 22 | — | — |

As illustrated in Table 4, when Example 1 and Comparative Examples 5 to 7 were compared, it was found that only the resin composition of Example 1 showed the chemical copper adhesion of 0.5 kgf/cm or more, the moisture content of 0.5 wt % or less, and the coefficient of thermal expansion of less than 20 ppm/° C.

FIG. 2 is a graph illustrating viscosity and thickness of a resin composition according to an example based on an amount of thickener.

When the thickener is added, the viscosity of the resin composition increases, and it is possible to manufacture a thick film of about 300 μm at a viscosity of about 1,000 cps or more. However, when the content of the thickener becomes more, the thermal and mechanical properties of the film itself can be lowered.

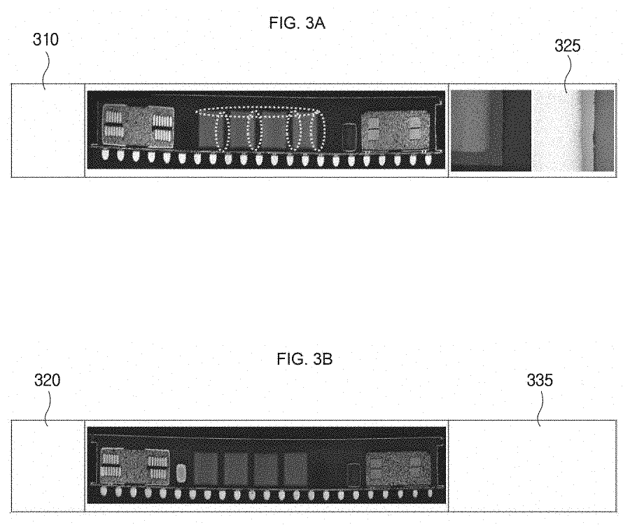

FIG. 3A illustrates results of reliability testing of a reference 310 after 1,000 cycles in a thermal cycle tester, and FIG. 3B illustrates an embodiment of this disclosure having a low coefficient of thermal expansion (CTE) 320, after 1,000 cycles in a thermal cycle tester in order to investigate thermal stability and mechanical strength.

In order to evaluate the reliability of the module, a total of 1,000 cycles were carried out, wherein a single cycle consisted of subjecting the sample to a low temperature (−55° C.) and then to a high temperature (125° C.) for 30 minutes in a reliability chamber.

At this time, as illustrated in FIG. 3A, when a high CTE encapsulation material was used as a control in the reference 310, CTE mismatches caused cracks and delamination at the interface 325 of the encapsulation material and a passive device.

On the other hand, as illustrated in FIG. 3B, when the low CTE encapsulation material prepared according to an embodiment 320 of this disclosure was used, no cracks and delamination were observed at the interface 335 of the encapsulation material and the passive device due to the reduction of CTE mismatches.

As described above, the resin composition of the examples disclosed herein is suitable for package molding, has low moisture content after hardening, and is excellent in adhesion to Cu, so that it is excellent in reliability when used as a molding material for packaging. Also, the resin composition may have excellent thermal/mechanical strength such as dissipation factor, TC, drop reliability and similar factors. Therefore, a blister of the back-side redistribution layer may be improved after reflowing.

It is possible to produce a film-type molding material based on the composition of this disclosure. It is also possible to form a film with a very high thickness (>200 μm) compared with general insulating materials.

The resin composition of the examples disclosed herein may also be used as a molding material for packaging to protect circuit boards and chips in which a build-up insulation material is applied in an outer layer, or a back-side coating layer to protect an outermost layer of package by utilizing an existing substrate manufacturing method. It is also possible to produce a substrate and a package having excellent reliability when the composition of this disclosure is applied.

Use of a resin composition for a printed circuit board and/or an IC package as described in this application provides a PCB and/or IC package having improved reliability, thermal stability, mechanical strength, and adhesion to a wiring layer.

Use of an insulation film or a mold build-up insulation film including the composition as described above, provides improved reliability, thermal stability, mechanical strength, and adhesion to a wiring layer.

The examples as described above provide a printed circuit board and/or an IC package including the composition described above, which has improved reliability, thermal stability and mechanical strength.

In addition, when a typical molding material in a granular or liquid type is used, expensive compression molding equipment may be needed, and since the molding and hardening are carried out with one equipment, a long processing time may also be needed.

On the other hand, by using the film-type molding material prepared by the resin composition of this disclosure, relatively inexpensive lamination equipment may be used and the hardening may be separately performed in a general oven after molding, which may shorten the processing time and improve the productivity of the final product.

While this disclosure includes specific examples, it will be apparent after an understanding of the disclosure of this application that various changes in form and details may be made in these examples without departing from the spirit and scope of the claims and theft equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A resin composition comprising:
an epoxy resin composite comprising epoxy groups, the epoxy resin composite comprising 5 to 10 parts by weight of a bisphenol “A” type epoxy resin, 5 to 10 parts by weight of a naphthalene epoxy resin, 10 to 40 parts by weight of a cresol novolac epoxy resin, more than 10 to 30 parts by weight of a rubber-modified epoxy resin, and 30 or more but less than 50 parts by weight of a biphenylaralkyl novolac resin;
a hardener composite comprising a dicyclopentadiene type hardener, a biphenylaralkyl novolac type hardener, and a xylok type hardener;
a hardening accelerator;
a filler; and
a thickener.

2. The resin composition of claim 1, further comprising a thermoplastic resin.

3. The resin composition of claim 1, wherein the resin composition is implemented with at least one of a printed circuit board and an integrated circuit (IC) packaging.

4. The resin composition of claim 1, wherein a total content of the hardener composite is in a range of 0.3 to 1.5 equivalents based on a mixed equivalent of the epoxy groups of the epoxy resin composite.

5. The resin composition of claim 1, wherein a content ratio of the dicyclopentadiene type hardener:the biphenylaralkyl novolac type hardener:the xylok type hardener in the hardener composite is 1:1:0.5 to 1.

6. The resin composition of claim 1, wherein the dicyclopentadiene type hardener in the hardener composite is contained in an amount of 0.1 to 0.5 parts by weight based on a total weight of the epoxy resin composite.

7. The resin composition of claim 1, wherein the biphenylaralkyl novolac type hardener in the hardener composite is contained in an amount of 0.1 to 0.5 parts by weight based on 100 parts by weight of the epoxy resin composite.

8. The resin composition of claim 1, wherein the Xylok type hardener in the hardener composite is contained in an amount of 0.1 to 0.5 parts by weight based on 100 parts by weight of the epoxy resin composite.

9. The resin composition of claim 1, wherein the hardening accelerator is contained in an amount of 0.1 to 1 part by weight based on 100 parts by weight of the epoxy resin composite.

10. The resin composition of claim 1, wherein the filler is contained in an amount of 30 to 70 parts by weight based on 100 parts by weight of the epoxy resin composite.

11. The resin composition of claim 1, wherein the filler is an inorganic filler.

12. An insulation film comprising the resin composition of claim 1.

13. The insulation film of claim 12, wherein the insulation film is applied to at least one of a build-up layer of a printed circuit board, a mold layer of panel level packaging, and a redistribution layer.

14. The insulation film of claim 12, wherein the insulation film has a thickness of 200 μm or more.

15. The insulation film of claim 12, wherein the insulation film has a moisture content of 0.5 wt % or less after hardening.

16. The insulation film of claim 12, wherein the insulation film has a thermal expansion coefficient of 20 ppm/° C. or less.

17. A product comprising the insulation film of claim 12.

18. The product claim 17, wherein the product is at least one of a printed circuit board and an integrated circuit (IC) package.
